(19) United States
(12) Patent Application Publication
(10) Pub. No.: US 2019/0363611 A1
(43) Pub. Date: Nov. 28, 2019

(54) DYNAMICALLY CONFIGURED PORTABLE POWER GENERATION

(71) Applicant: Power Scavengers, LLC, Madbury, NH (US)

(72) Inventors: Skylar Kirkwood Bagdon, Burlington, VT (US); George Thomas Philbrick, Burlington, VT (US); Adam Christopher Hookway, Barrington, NH (US); Jason West Kittell, Morrisville, VT (US)

(73) Assignee: Power Scavengers, LLC, Madbury, NH (US)

(21) Appl. No.: 16/421,916

(22) Filed: May 24, 2019

Related U.S. Application Data
(60) Provisional application No. 62/675,904, filed on May 24, 2018.

(51) Int. Cl. H02K 7/18; F03G 5/06

(52) U.S. Cl. CPC H02K 7/1853; F03G 2730/05; F03G 5/06

(57) ABSTRACT

Techniques are disclosed for dynamically configured portable power generation. A first motion of a first pull cord mechanically coupled to a first pull-cord generator is sensed, wherein the first pull cord is also mechanically coupled to a limb of a human body. A first tension-control signal is determined as a function of the first motion. The first-tension control signal is transmitted to a first variable tensioner configured to control a tension in the first pull cord. A tension in the first pull cord is set using one or more processors based on the first tension-control signal. Electrical power is generated using the first pull-cord generator, and power generation resulting from the generating electrical power is determined. Feedback is generated to set a tension based on the determined power generation.

### RELATED APPLICATIONS

This application claims the benefit of U.S. provisional patent application “Dynamically Configured Portable Power Generation” Ser. No. 62/675,904, filed May 24, 2018. The foregoing application is hereby incorporated by reference in its entirety.

### FIELD OF ART

The present disclosure relates generally to the field of power generation and particularly to dynamically configured portable power generation.

### BACKGROUND

People increasingly rely on various devices such as mobile phones and tablets for photography, GPS mapping, communication, and many other applications. Travelers who visit remote locations often carry a heavy burden of batteries to power various devices ranging from mobile phones and tablets to cameras and hearing aids, among others. When traditional power grid options are not available, travelers have typically relied on solar panels to meet the demand for electrical charge. Although solar panels can be used to charge batteries, solar power can be slow and fickle due to many factors such as cloud cover and distance from the equator during certain seasons. Further, many travelers rarely have an opportunity to optimally arrange a solar panel relative to the sun and wait for batteries to charge, and so solar panels are often worn on outer surfaces of backpacks or otherwise disposed in inefficient configurations that grant greater mobility to the traveler, but further limit energy production. Many stargazers, backpackers, and long-distance hikers are rarely exposed to sunlight due to night hiking efforts, cloudy weather that can persist for weeks in certain regions, and forest canopy cover that may block the sun indefinitely. Due to the extreme weight of batteries and the inefficiency of solar power for travelers on the move, a new portable power generation solution is needed.

### SUMMARY

In one aspect, the present disclosure is directed to a processor-implemented method for power generation which comprises: sensing a first motion of a first pull cord mechanically coupled to a first pull-cord generator wherein the first pull cord is also mechanically coupled to a limb of a human body; determining a first tension-control signal as a function of the first motion; transmitting the first-tension control signal to a first variable tensioner configured to control a tension in the first pull cord; setting a tension, using one or more processors, on the first pull cord based on the first tension-control signal; generating electrical power using the first pull-cord generator; determining power generation resulting from the generating electrical power; and providing feedback to the setting a tension based on the determined power generation.

In another aspect, the present disclosure is directed to an apparatus for power generation comprising: a pull cord designed and configured to couple a pull-cord generator with a limb of a human body; a variable tensioner designed and configured to control a tension in the pull cord; and a processor designed and configured to set a tension in the pull cord using the variable tensioner as a function of a sensed tension in the pull cord, wherein the processor is configured to first determine an amount of electrical power generated by the pull-cord generator and to then modify the tension in the pull-cord based on the determined amount.

In still another aspect, the present disclosure is directed to a computer program product embodied in a non-transitory computer readable medium for power generation, the computer program product comprising code which causes one or more processors to perform operations of: sensing a first motion of a first pull cord mechanically coupled to a first pull-cord generator wherein the first pull cord is also mechanically coupled to a limb of a human body; determining a first tension-control signal as a function of the first motion; transmitting the first-tension control signal to a first variable tensioner configured to control a tension in the first pull cord; setting a tension, using one or more processors, on the first pull cord based on the first tension-control signal; generating electrical power using the first pull-cord generator; and determining power generation resulting from the generating electrical power and providing feedback to the setting a tension based on the determined power generation.

In yet another aspect, the present disclosure is directed to a computer system for power generation comprising: a memory which stores instructions; one or more processors attached to the memory wherein the one or more processors, when executing the instructions which are stored, are configured to: sense a first motion of a first pull cord mechanically coupled to a first pull-cord generator wherein the first pull cord is also mechanically coupled to a limb of a human body; determine a first tension-control signal as a function of the first motion; transmit the first-tension control signal to a first variable tensioner configured to control a tension in the first pull cord; set a tension, using one or more processors, on the first pull cord based on the first tension-control signal; generate electrical power using the first pull-cord generator; determine an amount of electrical power generated by the first pull-cord generator; and modify the tension in the pull cord based on the determined amount.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for power generation.

FIG. 2 shows a block diagram for dynamically configured power generation.

FIG. 3 illustrates an example of a dynamically configured power generation apparatus.

FIG. 4A illustrates an example of structure components for dynamically configured power generation.

FIGS. 4B-C illustrate further examples of structure components for dynamically configured power generation.

FIG. 5 illustrates an example of an interface module for dynamically configured power generation.

FIG. 6 is a graph illustrating an example derivation of a tension control signal.

FIG. 7 illustrates an example system diagram for dynamically configured power generation.

### DETAILED DESCRIPTION

Techniques are disclosed for dynamically configured portable power generation. Embodiments allow users to generate portable power even when solar power is unavailable or inconvenient to collect by enabling them to extract energy passively from their own body movement without negatively affecting their mobility or energy levels. Pull cords can be attached to legs or arms with hooks or straps, and pull-cord generators can be disposed adjacent to the torso such that movement of the limbs can actuate the generators. To avoid negatively affecting mobility or energy levels, tension on the pull cord and power generation can be dynamically configured. By modulating the tension in a pull cord or power generation in a pull-cord generator based on user settings, biometric readings, sensed motions, or tension or power generated in either the same or a different pull cord, energy can be extracted passively from a user's movements without impeding their mobility or causing fatigue.

Aspects of the present disclosure enable users to tap their own body as a renewable energy source in order to power devices for communication, safety, and photography, among others, without having to dedicate time or energy to manually turning a crank or otherwise actuating an electric generator. In this way, users can focus their efforts on crucial tasks while small amounts of energy are selectively or continually harvested from their body movement. For example, cyclists could attach one or more pull-cord generators and one or more batteries to their handlebars and attach pull cords corresponding to the generators to their shoes, legs, or bike pedals. Hikers could attach one or more pull-cord generators to their belts and attach one or more pull cords corresponding to the generators to their shoes, legs, arms, or hands, or clothing or accessories attached thereto. In some embodiments, hikers may simply hold a strap or attach a strap to their wrist or ankle that is connected to a pull cord and associated pull-cord generator, which may be attached to a belt, held in the other hand, or attached to a shoe or leg. In some configurations, the pull cord may be threaded through a belt loop or button hole such that the users can release the strap any time they desire without having to worry about it falling to the ground. As will be understood by those of ordinary skill in the art, a vast array of embodiments are enabled by the present disclosure.

Many hikers have a preferred or dominant leg or arm, which may result in their wanting to use only that leg or arm to generate power, as using a weaker limb can lead to fatigue. Aspects of the present disclosure enable users to not only use a single pull-cord generator with a single limb, but also to dynamically configure the power generation such that, for example, two pull-cord generators could be used, one for each arm or each leg, and a power generation level and/or tension associated with pull-cords can be controlled not only as a function of limb movement, tension, power generation, and/or other values described herein, but also as a function of the side to which each pull-cord generator is attached on the user's body. For example, a user could configure a pull-cord generator to apply more tension and generate maximum power for a dominant leg while minimizing tension and power generation for the other leg. Further, a user could configure the minimal tension and power generation in a nondominant limb to increase periodically over time (e.g., hourly, weekly, or monthly) or as increased fitness levels are detected (e.g., a sensed or calculated increase in average pace or frequency of regular physical activity) or as input by a user. In this way, users can build strength in nondominant limbs without negatively impacting their movement or significantly increasing their energy usage. Many other uses and advantages of the present disclosure are discussed herein and further uses and advantages will become obvious to those of ordinary skill in the art from the following further description.

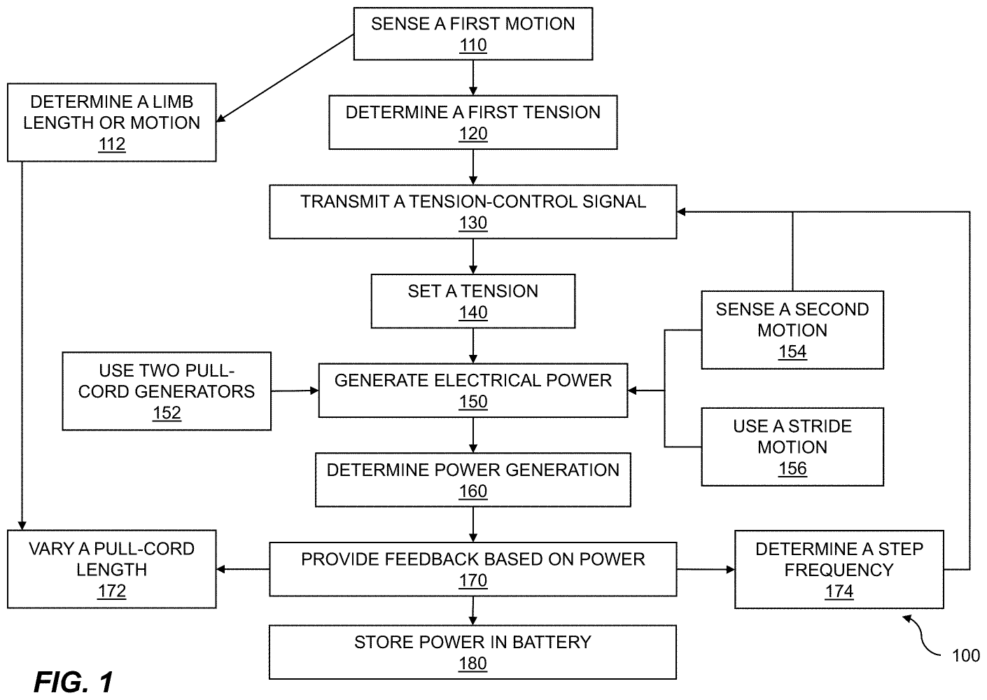

FIG. 1 is a flow diagram for power generation. The flow 100 includes sensing a first motion 110 of a first pull cord which is mechanically coupled to a first pull-cord generator, wherein the first pull cord is also mechanically coupled to a limb of a human body. The flow 100 further includes determining a first tension-control signal 120 as a function of the first motion. The tension-control signal may vary in proportion with the first motion. Alternatively, or additionally, the tension-control signal may be set to certain values and/or may be scaled by certain factors when the first motion meets certain requirements, such as a threshold set by default or by a user for direction, velocity, or acceleration of movement.

The flow 100 further includes transmitting 130 the first tension-control signal to a first variable tensioner configured to control a tension in the first pull cord. A tension is set 140, using one or more processors, on the first pull cord based on the first tension-control signal. Under control of the one or more processors, the variable tensioner may apply tension to the pull cord directly or by transmitting a signal to a pull-cord generator that applies the tension. In some embodiments, a pull-cord generator may act as a variable tensioner. The flow 100 further includes generating electrical power 150 using the first pull-cord generator or optionally using a stride motion 156 of the human body.

The flow 100 may further include sensing a second motion 154 of the first pull cord, comparing the second motion to the first motion, determining a second tension-control signal as a function of the comparing, and transmitting the second tension control signal to the first variable tensioner, wherein the first variable tensioner optionally controls tension in the first pull cord using the first pull-cord generator. Accordingly, differences between a first sensed motion and a second sensed motion can be used to determine tension-control signals. In some embodiments, more than one pull-cord generator may be used. The flow 100 may include sensing a second motion 154 of a second pull cord mechanically coupled to a second pull-cord generator, wherein the second pull cord is also mechanically coupled to a second limb, allowing generation of electrical power using a combination of a first pull-cord generator and a second pull-cord generator 152. In some embodiments, movements sensed in the first pull cord can be used to determine tension-control signal or power generation characteristics for a pull-cord generator associated with a second pull cord. For example, while a first pull cord is generating power, a pull-cord generator associated with a second pull cord may be disabled or a tension-control signal may be modified (e.g., increased, decreased, set to a maximum, or set to zero).

The flow 100 further includes determining power generation 160 resulting from the generating electrical power and providing feedback 170 to set a tension based on the determined power generation. For example, if power generation is sensed and determined to be at a maximum for a certain tension-control signal value, tension on a corresponding pull cord may be increased by a variable tensioner associated with that pull cord in order to enable additional power generation. In some embodiments, the flow 100 may include varying a length 172 that the first pull cord extends from the first pull-cord generator and/or determining a frequency of steps 174, by the human body, using the first motion. In some embodiments, a sensed motion may be used to determine a limb length or motion 112 using a look-up table, and the limb length or motion can be used to vary a pull-cord length 172. For example, a look-up table may store a correspondence between sensed motions and predicted limitations, thus enabling a length of a pull cord to be limited based on an estimated limb length or so that it will not get caught on and tangled in grass or other obstacles. As another example, such a look-up table may enable the length of the pull cord to be extended or automatically released or cut when unexpected movements are sensed, either by detecting movement on the pull cord or through a separate sensor such as a gyroscope. Additionally, such a look-up table may enable the pull cord to be extended or automatically released or cut when extreme tension is sensed on the pull cord. In this way, the length and connectivity of the pull cord can be controlled in order to prevent the pull cord from getting tangled or from otherwise impeding the user's movement, which may lead to injury.

In some embodiments, the flow 100 may include using the frequency of steps to determine a first tension-control signal. For example, users may desire to vary the tension-control signal and power generation in accordance with their pace. A user may wish to decrease the tension-control signal to limit tension either while at a slower pace to save energy or at a faster pace to take advantage of the additional available energy. Alternatively, a user may wish to increase the tension when moving at a slower pace so as not to be as impeded when moving at a faster pace and perhaps wanting to maintain that faster pace. The flow 100 may further include storing in a battery 180, as renewable energy, the electrical power that is generated while a person is hiking. In this way, users can generate power in a passive fashion by dynamically garnering energy from their own body movements. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

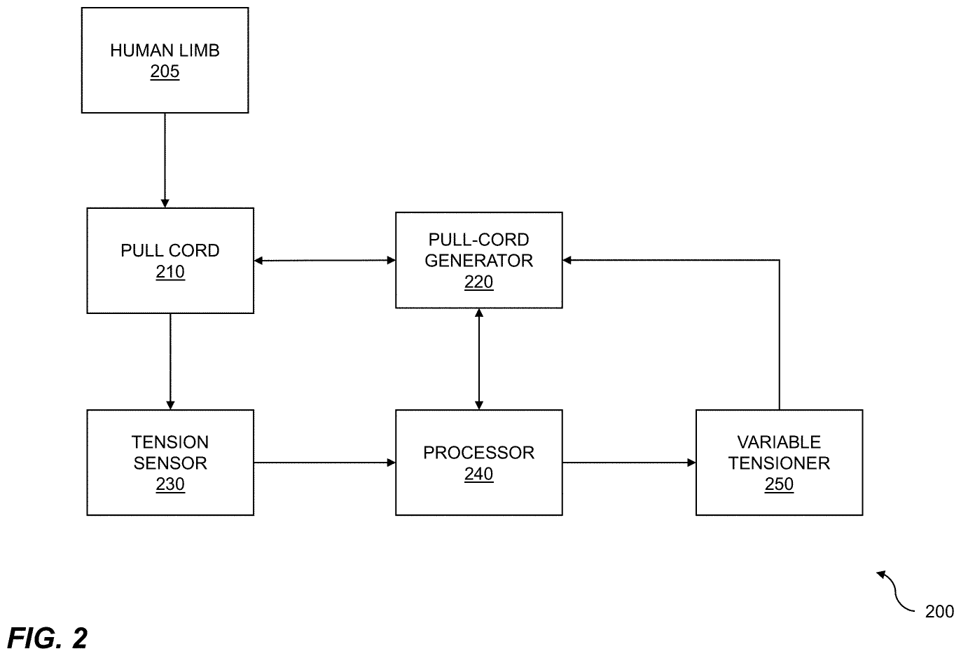

FIG. 2 shows a block diagram of a system for dynamically configured power generation 200. In embodiments, the system for dynamically configured power generation 200 includes a pull cord 210 designed and configured to couple a pull-cord generator 220 with a limb of a human body 205. The system 200 includes a variable tensioner 250 designed and configured to control a tension in the pull cord 210, optionally by controlling the pull-cord generator 220, and a processor 240 designed and configured to set a tension in the pull cord using the variable tensioner as a function of a tension sensed in the pull cord by a tension sensor 230. The processor 240 is configured to determine an amount of electrical power generated by the pull-cord generator 220 and to modify the tension in the pull cord 210 based on the determined amount. Arrows in FIG. 2 indicate information and energy flow. For example, the human limb 205 applies a force to the pull cord 210, which then causes an output on the tension sensor 230 and may cause actuation of the pull-cord generator 220. However, the pull-cord generator can also apply force to the pull cord 210, optionally by way of variable tensioner 250. The tension sensor 230 and/or pull-cord generator provide inputs to the processor 240, which then controls the variable tensioner 250 and/or pull-cord generator 220 in order to manage tension in the pull cord 210 and/or characteristics of power generation. Further inputs and controls may be incorporated if desired, such as manual user controls and/or biometric inputs, among others.

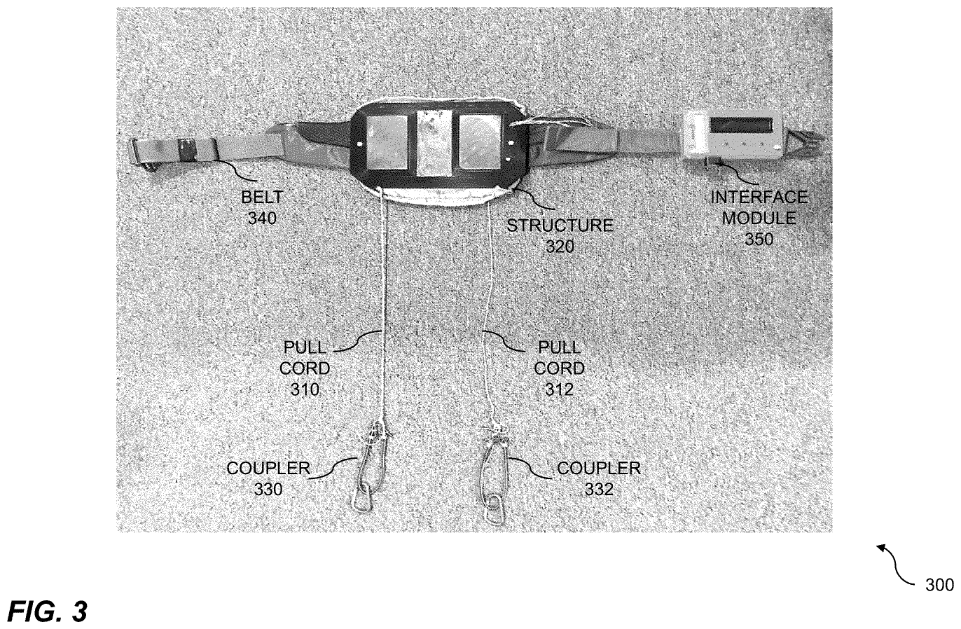

FIG. 3 illustrates an example of a dynamically configured power generation apparatus that can be used to implement the flow 100 of FIG. 1. Pull cords 310 and 312 extend from a structure 320 which houses pull-cord generators, and terminate with couplers 330, 332 that allow the pull cords to be attached to a piece of clothing, footwear, or directly to a limb. The structure 320 may be disposed on a belt 340 or may otherwise include wearable features such as clips, straps, or hook and loop fasteners. In some embodiments, the structure may be coupled with an interface module 350 that can allow a user to control the operation of the pull-cord generators and other components disposed within the structure.

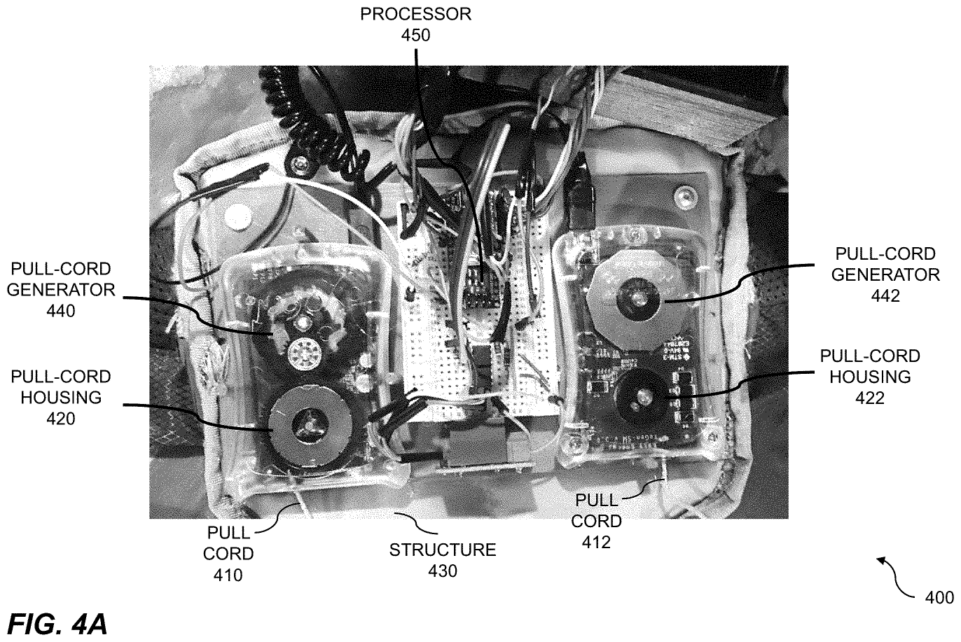

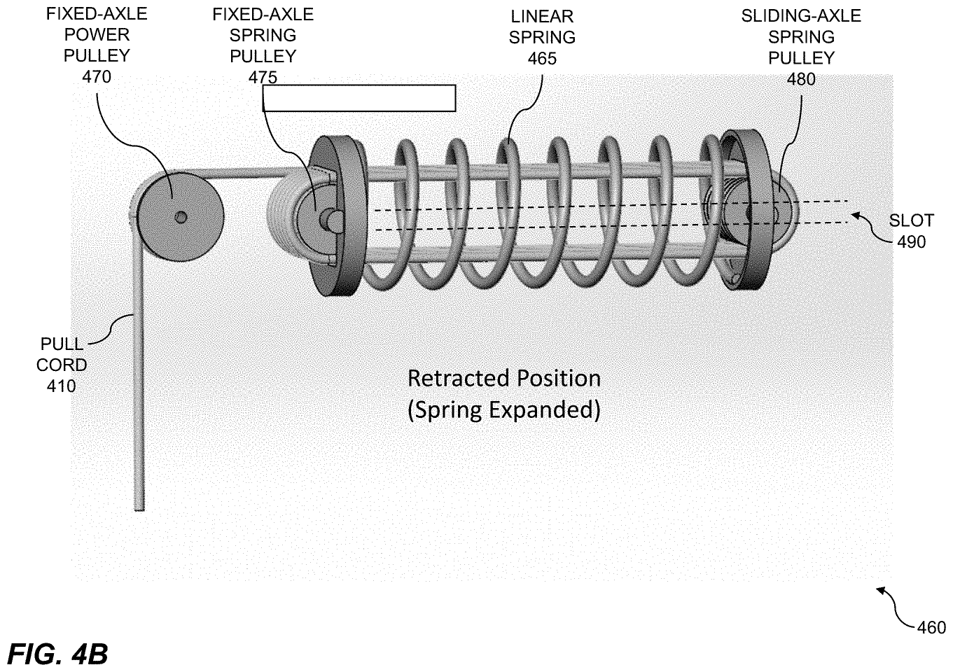

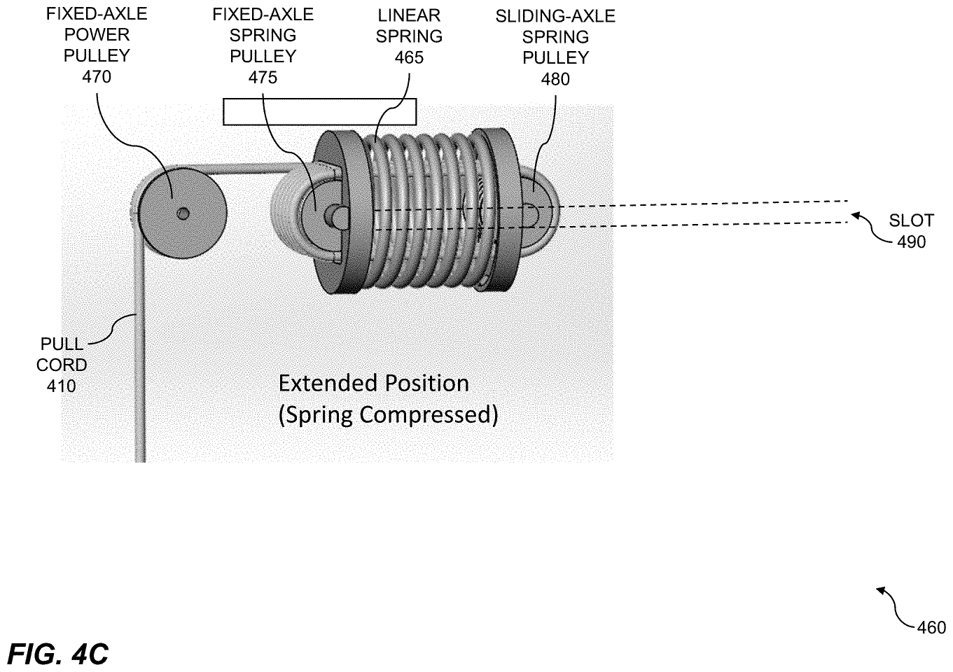

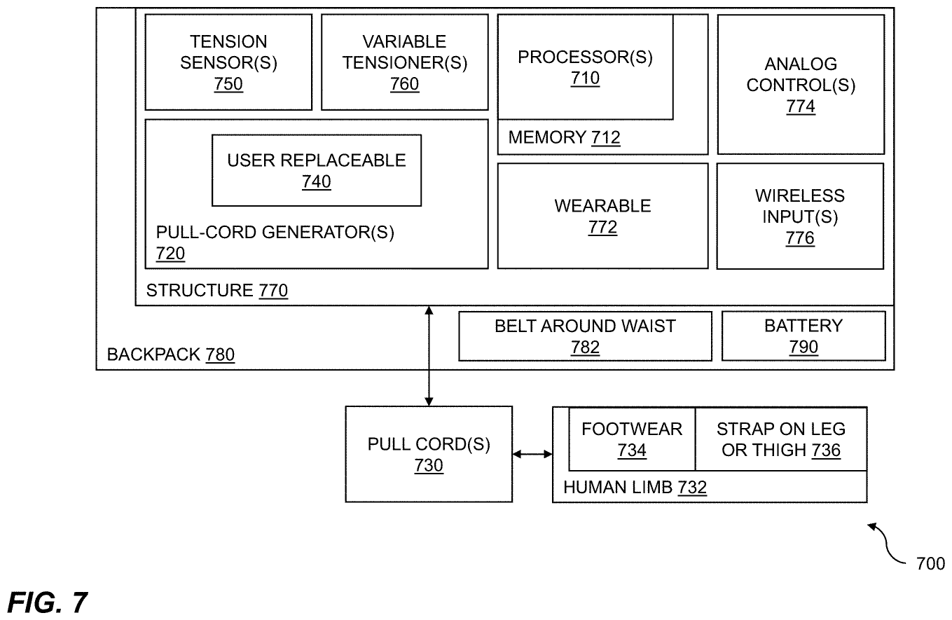

FIG. 4A illustrates an example of structure components 400 for use in dynamically configured power generation systems and methods like those described in connection with FIGS. 1-3. As shown in FIG. 4A, a pull cord 410 may extend from a pull-cord housing 420 adjacent to a pull-cord generator 440 in a structure 430. In some embodiments, the pull-cord housing 420 may include a toothed gear mechanically coupled with a toothed gear associated with the pull-cord generator in order to enable the pull cord 410 to generate electricity when it is pulled out and/or allowed to retract into the pull-cord housing. This can be accomplished using one or more springs disposed within the pull-cord housing. The pull-cord generator 440 can act as a variable tensioner in some embodiments and may be user replaceable and removably attached to the structure as described in greater detail in the context of FIG. 7, below. As shown, the structure 430 may further include a second pull cord 412, a second pull-cord housing 422, and a second pull-cord generator 442. The scope of the disclosure is not so limited, however; the structure 430 may include any number of pull cords, pull-cord housings, and pull-cord generators. The processor 450 may control and/or interface with one or more of the pull-cord generators in order to control tension in a corresponding pull cord, to control power generation, and/or to ensure that power is properly routed from the pull-cord generators to a battery.

FIG. 4B illustrates an alternative example of a pull-cord retraction mechanism 460 designed and configured to repeatedly retract the pull cord 410 during use, e.g., after each footstep or other user movement that results in extension of the pull cord. In this example, the pull-cord retraction mechanism 460 utilizes a linear spring 465 with pulleys at either end. A wound constant force spring, or clock spring, is typically used in compact cord retraction mechanisms. However, such springs typically offer a maximum cycle life of approximately 200,000 cycles, which can result in insufficient durability when utilized in accordance with the present disclosure, where the spring may be compressed or expanded multiple times per minute. For this reason, in some embodiments, the pull-cord retraction mechanism 460 is designed to use a linear spring 465, which is far more durable and can have a cycle life well above 1,000,000 cycles. However, it is noted that any type of spring may be used to implement aspects of the present disclosure, depending on design requirements. In some embodiments, the linear spring 465 may have an outer diameter of 0.875 inches, while in other embodiments the linear spring 465 may have an outer diameter of from 0.5 to 1.0 inches, although other sizes of springs may be used. In some embodiments, the linear spring 465 may have a 1.5 inch deflection for active pull usage and an additional 2 inches of travel for full retraction of the pull cord 410. In some embodiments, a spring with a longer resting length may be used to lower spring stress.

One set of pulleys, including a fixed-axle power pulley 470 and a fixed-axle spring pulley 475, is securely positioned within a pull-cord housing. On the opposite end of the linear spring 465 from the fixed set of pulleys, a sliding-axle spring pulley 480 is slidably disposed in a slot 490 formed by opposing channels (not shown) of a pull-cord housing such that the sliding-axle spring pulley 480 slides back and forth as the pull cord 410 is extended and retracted and, as a result, the linear spring 465 expands and contracts. The fixed-axle spring pulley 475 and sliding-axle spring pulley 480 are arranged relative to the linear spring 465 such that when the pull cord 410 is wound between the fixed-axle spring pulley 475 and sliding-axle spring pulley 480, the winding of pull cord 410 between the spring pulleys is contained within the diameter of the cylindrical spring, as shown in FIG. 4B. By routing the pull cord 410 inside of the diameter of the linear spring 465, the pull-cord retraction mechanism 460 remains compact while still maintaining the durability needed for extended use. Both durability and compact size are desirable for a device that is designed to be worn or carried on the body and used to produce electricity for extended periods of time.

As shown in FIG. 4C, when tension is applied to the pull cord 410, the sliding-axle spring pulley 480 is drawn towards the fixed-axle spring pulley 475 and compresses the linear spring 465. When tension in the pull cord 410 is released, the linear spring 465 urges movement of at least one of the pulleys, resulting in retraction of the pull cord. For example, as shown in FIG. 4B, the force of the compressed spring drives the sliding-axle spring pulley 480 back toward its original or resting position and retracts the pull cord 410. In some embodiments, the pull cord 410 may actuate a fixed-axle power pulley 470, which may drive a small alternator to produce electricity as the pull cord 410 is extended (see FIG. 4C) and retracted.

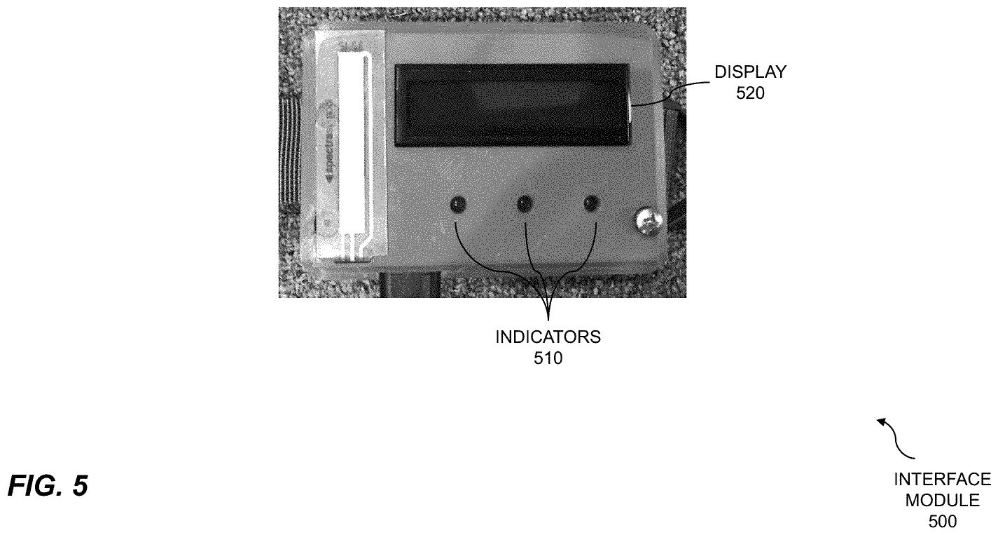

FIG. 5 illustrates an example of an interface module 500 for dynamically configured power generation. The interface module 500 (see FIG. 3) may include one or more indicators 510 and one or more displays 520, either or both of which may indicate battery status, maintenance status, power generation status, step counts, estimated distance traveled, and/or tension-control signal status, among other information. The module 500 may further include one or more user input interfaces, such as sliders, knobs, buttons, or other components that enable a user to modify tension and/or power generating characteristics, among other settings. The interface module 500 may be carried separately from other components, such as pull cords and pull-cord generators, in order to allow users to freely interact with the module when the pull-cord generators or other components of a dynamic power generation apparatus are located in less accessible locations.

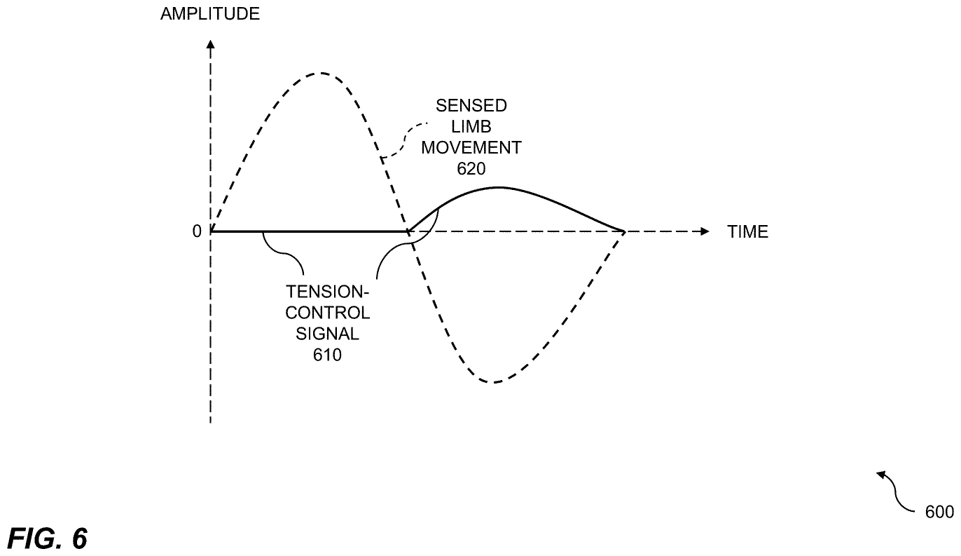

FIG. 6 is a graph 600 illustrating an example derivation of a tension control signal 610. As discussed above, the tension control signal 610 may be derived by a processor, such as the processor 240 of FIG. 2, as a function of inputs received from a pull-cord generator and/or a tension sensor, such as the pull-cord generator 220 and tension sensor 230 of FIG. 2. As shown in FIG. 6, the processor may determine a sensed limb movement 620 using one or more sensors, such as tension sensor 230 of FIG. 2, and may derive a tension-control signal 610 as a function of the determined limb movement. In the example of FIG. 6, the tension-control signal 610 is set to zero when the sensed limb movement 620 is in a first direction (e.g., forward motion), but is set to a value proportional to the sensed limb movement when the sensed limb movement proceeds in a different direction from the first direction. For example, it may be desired that a limb be free of any tension while it is in front of the body or moving forward relative to the body, while it may be desired to maximize power generation and/or tension when a limb is behind the body or moving backward relative to the body. As such, sensed limb movement 620 can be a position relative to the center of mass of a user carrying a pull-cord generator, a velocity of a limb, an acceleration of a limb, or even an estimated level of exertion of a limb movement or an estimated exhaustion level of a limb. Thus, the tension control signal 610 can be derived from a position, velocity, acceleration, estimated level of exertion, or estimated exhaustion level, among others. By enabling the tension control signal 610 to vary as a function of sensed limb movement 620, users can comfortably and effectively generate power without hindering their movement or risking exhaustion, both of which can lead to injury. In some embodiments, relationships between the tension-control signal 610 and sensed limb movement 620 can be determined as a function of look-up tables or other information stored in a memory.

In some embodiments, aspects of the present disclosure include a processor-implemented method for power generation comprising: sensing a first motion of a first pull cord, wherein the first pull cord is mechanically coupled to a first pull cord generator; determining a first tension control signal as a function of the first motion; transmitting the first tension control signal to a first variable tensioner configured to control a tension in the first pull cord; sensing a second motion of the first pull cord; comparing the second motion to the first motion; determining a second tension control signal as a function of the comparing; and transmitting the second tension control signal to the first variable tensioner, wherein the first variable tensioner controls tension in the first pull cord using a first pull cord generator.

The method may further comprise determining a speed of the first pull cord based on the comparing and determining the second tension control signal as a function of the speed. Additionally, the method may further comprise determining an acceleration of the first pull cord based on the comparing and determining the second tension control signal as a function of the acceleration. The method may also comprise determining a change in direction of the first pull cord based on the comparing and determining the second tension control signal as a function of the change in direction. In some embodiments, the method may include determining a maintenance reminder status based on the comparing and displaying an indication to a user that a field service operation should be performed as a function of the maintenance reminder status.

The method may further comprise sensing a first motion of a second pull cord, wherein the second pull cord is mechanically coupled to a second pull cord generator; determining a third tension control signal as a function of the first motion of the second pull cord; transmitting the third tension control signal to a second variable tensioner configured to control a tension in the second pull cord; sensing a second motion of the second pull cord; comparing the second motion of the second pull cord to the first motion of the second pull cord; determining a fourth tension control signal as a function of the comparing the second motion of the second pull cord to the first motion of the second pull cord; and transmitting the fourth tension control signal to the second variable tensioner, wherein the second variable tensioner controls tension in the second pull cord using a second pull cord generator. In some embodiments, the method may include determining a tension control signal for the first pull cord as a function of a tension control signal transmitted to the second pull cord. In some embodiments, the method may include determining a tension control signal for the first pull cord as a function of a sensed motion of the second pull cord.

FIG. 7 illustrates an example system diagram for dynamically configured power generation. A block diagram 700 can represent a system, an apparatus, and so on for power generation, which may include and/or enable any one or more of the aspects discussed above in connection with FIGS. 1-6. The block diagram includes one or more processors 710 and a memory 712. The memory can store instructions, values, parameters, weights, look-up tables, and so on. A first motion of a first pull cord 730 mechanically coupled between a first pull-cord generator 720 and a limb 732 of a human body, such as an arm or leg, is sensed by a tension sensor 750. The first pull cord 730 can be coupled with footwear 734 worn on a foot of the leg using removably securable attachments such as carabiners or a buckle, removably attached to an ankle region or thigh region of the leg with a strap 736, or otherwise arranged such that a regular or semiregular movement of a user of the device will result in the first pull cord 730 actuating the first pull-cord generator 720 and thus generating power.

A first tension-control signal (see, e.g., FIG. 6) is determined as a function of the first motion. The first-tension control signal is transmitted to a first variable tensioner 760 configured to control a tension in the first pull cord 730. A tension is set on the first pull cord using one or more processors 710 as a function of the first tension-control signal. Electrical power is generated using the first pull-cord generator 720. This power is determined using one or more sensors and/or one or more processors 710. Feedback is generated as a function of the determined power generation and is provided to the one or more processors 710 for use in determining a tension-control signal and/or setting a tension.

In embodiments, a structure 770 houses the first pull-cord generator 720, the first variable tensioner 760, and a second pull-cord generator 720. The structure 770 can be coupled and comfortably secured to a human body in any number of ways, such as a belt around a waist 782 (see, e.g., FIG. 3), hook and loop fasteners disposed on mating surfaces of the structure 770 and a piece of clothing or an accessory such as a backpack 780, or placement in a backpack, among others. In embodiments, the structure 770 may comprise a backpack 780 worn on a human body. In some embodiments, the structure may comprise or include a wearable 772 device or include features enabling the structure to be wearable, such as hook and loop fasteners, straps and buckles, and so on.

The first pull-cord generator 720 can be user replaceable 740 and removably attached to the structure 770. Accordingly, the pull-cord generator 720 may be field serviceable such that users can carry replacement pull-cord generators to install in place of older or differently configured generators when necessary or desired. For example, some pull-cord generators 720 may more efficiently generate power when the user is ascending in elevation than others, which may more efficiently generate power when the user is descending in elevation. As such, users may select a pull-cord generator 720 based on aspects of the user's intended route, such as whether the user will ascend in elevation more than descend, and install the selected pull-cord generator in the structure 770 in the field. The pull-cord generator may be removably attached to the structure using clips, latches, or hook and loop fasteners, among others.

The structure 770 may include one or more analog controls 774 for adjusting the tension in the pull cord 730 or adjusting the generation of electrical power by the pull-cord generator 720. The analog controls 774 may include sliders, knobs, buttons, or other components that enable a user to modify tension, power generating characteristics, or other settings. In embodiments, digital controls such as numerical keypads or other input mechanisms can be used in addition to or in place of the analog controls 774. In some embodiments, the structure 770 may include a wireless input 776 for adjusting the tension in the pull cord 730 or for adjusting the generating of electrical power by the pull-cord generator 720. For example, the wireless input 776 may accept inputs from mobile phones, watches, or other devices equipped with wireless technology such as near-field communications circuits or other wireless communication interfaces. In some embodiments, the wireless input 776 may accept inputs from satellites or biometric devices.

In some embodiments, the processor 710 may vary a length that the first pull cord 730 extends from the first pull-cord generator 720. For example, the processor 710 may vary the length of the pull cord 730 as a function of a motion of the limb 732 and/or a length of the limb. If the user has programmed a stride length or the processor 710 has determined an average stride length using a tension sensor 750 or another sensor, the processor may cause the variable tensioner 760 to decrease tension on the pull cord 730 when a limb is determined or predicted to be reaching a forward-most and/or rearward-most position. In this way, users can dynamically control power generation and/or tension based on their strengths and preferences. For example, a strong user wishing to maximize power generation may choose to maintain tension on the pull cord 730 when a limb changes direction. However, a user who is not as strong may choose to reduce tension on the pull cord when the limb changes direction and/or may configure the pull-cord generator 720 such that power is generated only when a limb is already in motion. This will serve to reduce the impact of the tension and/or power generation on their gait and energy levels.

A battery 790 may be disposed within the structure 770, the backpack 780, a separate interface module (see, e.g., FIG. 5), or may be otherwise collocated with the structure 770 such that power generated by the pull-cord generator 720 can be stored in the battery. In embodiments, the battery 790 is external to the structure 770.

In embodiments, a system for power generation includes: a memory which stores instructions; one or more processors attached to the memory wherein the one or more processors, when executing the instructions which are stored, are configured to: sense a first motion of a first pull cord mechanically coupled to a first pull-cord generator wherein the first pull cord is also mechanically coupled to a limb of a human body; determine a first tension-control signal as a function of the first motion; transmit the first-tension control signal to a first variable tensioner configured to control a tension in the first pull cord; set a tension, using one or more processors, on the first pull cord based on the first tension-control signal; generate electrical power using the first pull-cord generator; and determine an amount of electrical power generated by the first pull-cord generator and modify the tension in the pull cord based on the determined amount.

Each of the above methods may be executed using one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited neither to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the described functions.

Any combination of one or more computer readable media may be utilized, including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for power generation comprising:
sensing a first motion of a first pull cord mechanically coupled to a first pull-cord generator wherein the first pull cord is also mechanically coupled to a limb of a human body;
determining a first tension-control signal as a function of the first motion;
transmitting the first tension-control signal to a first variable tensioner configured to control a tension in the first pull cord;
setting a tension, using one or more processors, on the first pull cord based on the first tension-control signal;
generating electrical power using the first pull-cord generator; and
determining power generation resulting from the generating electrical power and providing feedback to the setting a tension based on the determined power generation.

2. The method of claim 1 further comprising sensing a second motion of a second pull cord mechanically coupled to a second pull-cord generator, wherein the second pull cord is also mechanically coupled to a second limb.

3. The method of claim 2 further comprising generating electrical power using a combination of the first pull-cord generator and the second pull-cord generator.

4. The method of claim 2 wherein a structure houses the first pull-cord generator, the first variable tensioner, and the second pull-cord generator.

5. The method of claim 4 wherein the structure is coupled to a human body using a belt around a waist.

6. The method of claim 4 wherein the structure comprises a backpack worn on a human body.

7. The method of claim 4 wherein the limb is a leg.

8. The method of claim 7 wherein the first pull cord is coupled with footwear worn on a foot of the leg.

9. The method of claim 7 wherein the first pull cord is coupled with a strap attached to an ankle region or thigh region of the leg.

10. The method of claim 4 wherein the structure comprises a wearable device.

11-15. (canceled)

16. The method of claim 2 wherein the generating electrical power is accomplished using a stride motion of the human body.

17. The method of claim 1 further comprising sensing a second motion of the first pull cord; comparing the second motion to the first motion; determining a second tension-control signal as a function of the comparing; and transmitting the second tension-control signal to the first variable tensioner, wherein the first variable tensioner controls tension in the first pull cord using the first pull-cord generator.

18. The method of claim 1 further comprising varying a length that the first pull cord extends from the first pull-cord generator.

19-21. (canceled)

22. The method of claim 1 further comprising determining a frequency of steps, by the human body, using the first motion.

23. The method of claim 22 further comprising using the frequency of steps in the determining the first tension-control signal.

24. The method of claim 1 further comprising storing, in a battery, the electrical power that was generated.

25-26. (canceled)

27. An apparatus for power generation comprising:
a pull cord designed and configured to couple a pull-cord generator with a limb of a human body;
a variable tensioner designed and configured to control a tension in the pull cord; and
a processor designed and configured to set a tension in the pull cord using the variable tensioner as a function of a sensed tension in the pull cord, wherein the processor is configured to determine an amount of electrical power generated by the pull-cord generator and modify the tension in the pull cord based on the determined amount.

28. The apparatus of claim 27, further comprising a pull-cord retraction mechanism including a spring mounted between two pulleys, wherein the pull cord is wound between the pulleys and within the spring.

29. The apparatus of claim 28, wherein the spring urges movement of at least one of the pulleys after the pull cord has been extended and released, resulting in retraction of the pull cord.

30. (canceled)

31. A computer system for power generation comprising:
a memory which stores instructions;
one or more processors attached to the memory wherein the one or more processors, when executing the instructions which are stored, are configured to:
sense a first motion of a first pull cord mechanically coupled to a first pull-cord generator wherein the first pull cord is also mechanically coupled to a limb of a human body;
determine a first tension-control signal as a function of the first motion;
transmit the first tension-control signal to a first variable tensioner configured to control a tension in the first pull cord;
set a tension, using one or more processors, on the first pull cord based on the first tension-control signal;
generate electrical power using the first pull-cord generator; and
determine an amount of electrical power generated by the first pull-cord generator and modify the tension in the first pull cord based on the determined amount.
